(19) United States
(12) Patent Application Publication
(10) Pub. No.: US 2019/0217207 A1
(43) Pub. Date: Jul. 18, 2019

(54) GAME SERVICE PROVISION METHOD AND SYSTEM BASED ON MATHEMATICAL PRINCIPLES

(71) Applicant: FEELMATHRED CORP., Seoul (KR)

(72) Inventor: Jon Lark KIM, Seoul (KR)

(73) Assignee: FEELMATHRED CORP., Seoul (KR)

(21) Appl. No.: 16/304,592

(22) PCT Filed: May 3, 2018
(86) PCT No.: PCT/KR2018/005131

§ 371 Date: Nov. 26, 2018

(30) Foreign Application Priority Data
May 4, 2017 (KR) 10-2017-0056759

(51) Int. Cl. A63F 13/822; A63F 13/537

(52) U.S. Cl. CPC A63F 13/822; A63F 13/537

(57) ABSTRACT

The present invention provides a method of providing game service based on mathematical principles, which includes: a first step of receiving a game selection signal from any one of first and second user terminals; a second step of generating a matrix-shaped game board including M×N unit boards, and allowing the M×N unit boards to be indicated in a not-in-use state on the game board; a third step of alternately receiving unit board selection signals, and repeating a process of allowing the selected unit boards to be indicated in an in-use state on the game board when the shape of the unit boards satisfies game rules until a unit board satisfying the game rules cannot be selected; and a fourth step of determining that the user of one user terminal corresponding to a sequential position when a unit board satisfying the game rules cannot be selected is a loser.

### TECHNICAL FIELD

The present invention relates to a game service provision method and system, and more specifically to a method and system for providing game service according to various game rules based on mathematical principles.

### BACKGROUND ART

With the development of the Internet, smartphones, etc., various types of game services have been provided using computers or smartphones. However, such conventional game services have a limitation in that an educational effect is low because most of the game services are directed to interest-oriented games.

Meanwhile, although there have been proposed board games designed such that cards or game pieces are placed on a game board and games are played in accordance with predetermined rules, most of the conventional board games are also games in which pairing is performed using arrangements of pictures or numbers, e.g., via arrangements of pictures or numbers having similar patterns. These rules have no specific background mathematical principles, and thus the conventional board games have a limitation in that interest-oriented games are simply played.

In other words, there has not been yet provided a game service that enables a user to naturally and amusingly learn mathematical principles by providing game service based on the principles of figures and arithmetic operations.

### DISCLOSURE

### Technical Problem

The present invention has been conceived to overcome the above-described limitations, and an object of the present invention is to provide a method and system that are capable of naturally providing effects of mathematics education while preventing interest from being lost through game service which allows unit boards to be selected in accordance with figure- or arithmetic operation-based game rules via a game board including a plurality of unit boards.

### Technical Solution

In order to accomplish the above object, the present invention provides a method of providing game service based on mathematical principles, the method including: a first step of receiving a game selection signal from any one of first and second user terminals; a second step of generating a matrix-shaped game board including M×N unit boards (where M and N are natural numbers), and allowing the M×N unit boards to be indicated in a not-in-use state on the game board via the display units of the first and second user terminals; a third step of alternately receiving unit board selection signals for unit boards in a not-in-use state from the first and second user terminals, and repeating a process of allowing the selected unit boards to be indicated in an in-use state on the game board displayed on the display units of the first and second user terminals when the shape of the unit boards selected by the unit board selection signals satisfies game rules for a selected game until a unit board satisfying the game rules cannot be selected from unit boards in a not-in-use state; and a fourth step of determining that the user of one of the user terminals corresponding to a sequential position when a unit board satisfying the game rules cannot be selected from unit boards in a not-in-use state is a loser.

In this case, the method may further include, before the first step, a step of providing a menu interface configured to enable a game to be selected from a plurality of games to the first and second user terminals and receiving a game selection signal for a game selected by any one of the first and second user terminals via the menu interface.

Furthermore, the third step may include transmitting game board information to the first and second user terminals so that the selected unit boards can be indicated in an in-use state on the game board displayed on the display units of the first and second user terminals when the shape of the unit boards selected by the unit board selection signals satisfies the game rules for the selected game, and renewing, by the first and second user terminals, the game board on the display units based on the received game board information.

Furthermore, the game rules may be figure-based rules configured to allow the shape of a specific figure to be indicated on the game board by using some of the unit boards.

Furthermore, the figure-based rules may allow the vertices of a plane figure or solid figure to be indicated on the game board by using some of the unit boards.

Furthermore, the figure-based rules may allow the sides of a plane figure or solid figure to be indicated on the game board by using some of the unit boards.

Furthermore, the plane figure may be any one of a triangle, a rectangle, a pentagon, a hexagon, a rhombus, and a circle, and the solid figure may be any one of a tetrahedron, a triangular pyramid, a hexahedron, and a triangular prism.

Furthermore, the figure-based rules may allow the planar figure, line symmetric or point symmetric shape of the plane figure or solid figure to be indicated on the game board by using some of the unit boards.

Furthermore, the game rules may be arithmetic operation-based rules configured to allow the result of an arithmetic operation to be indicated on the game board by using some of the unit boards.

Furthermore, the arithmetic operation may be any one of factorization into prism factors, factorization, division, multiplication, an equation, and a proportional expression.

According to another aspect of the present invention, there is provided a game service provision system for providing the above-described game service provision method, the game service provision system including: a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and the game performance unit configured to generate a matrix-shaped game board including M×N unit boards, to allow the M×N unit boards to be indicated in a not-in-use state on the game board through the display units of the first and second user terminals via the user connection unit, and to determine whether the shape of unit boards selected by unit board selection signals received from the first and second user terminals satisfies game rules for the selected game based on the unit board selection signals; wherein when it is determined that the game rules are satisfied, the game performance unit repeats the process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

### Advantageous Effects

According to the present invention, there can be provided the method and system that are capable of naturally providing effects of mathematics education while preventing interest from being lost through game service which allows unit boards to be selected in accordance with figure- or arithmetic operation-based game rules via a game board including a plurality of unit boards.

### DESCRIPTION OF DRAWINGS

FIG. 1 is a diagram showing the overall connection relationship between a game service provision system (100) based on mathematical principles and user terminals (200 and 300) according to the present invention;

FIG. 2 is a flowchart showing a game service provision method that is performed in the system (100);

FIG. 3 is a screen showing an example of a menu interface;

FIG. 4 shows an example of a game board that is displayed on the display units of the user terminals (200 and 300);

FIG. 5 is a view illustrating a case where game rules are figure (rectangle)-based rules;

FIG. 6 shows an example of the game service provision method according to the present invention, which shows a case where game rules are figure-based rules and a figure is a right-angled triangle;

FIG. 7 shows other examples of the figure-based rules;

FIG. 8 shows another example of the game service provision method according to the present invention, which shows a case where game rules are arithmetic operation-based rules and an arithmetic operation is factorization;

FIGS. 9 and 10 show other examples of the arithmetic operation-based rules;

FIG. 11 shows another example of the arithmetic operation-based rules, and is directed to a case where a specific number n is set, an arithmetic operation of ×1/n (where the result thereof is truncated to its positive integer) is performed on connected unit boards in a not-in-use state in a specific row or column of a game board, and a number of unit boards equal to a value corresponding to the result value of the operation are connected to each other; and

FIG. 12 shows the configuration of the system (100) that performs the game service provision methods described with reference to FIGS. 1 to 11.

### BEST MODE

Embodiments of the present invention will be described in detail below with reference to the accompanying drawings.

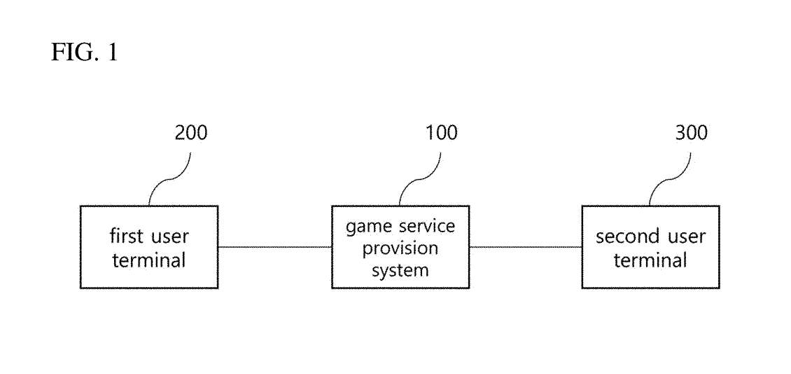

FIG. 1 is a diagram showing the overall connection relationship between a game service provision system 100 based on mathematical principles and user terminals 200 and 300 according to the present invention.

As shown in FIG. 1, the game service provision system based on mathematical principles (hereinafter simply referred to as the “system 100”) is connected to the first and second user terminals 200 and 300 over a network (not shown), and provides game service based on mathematical principles to a user via the first and second user terminals 200 and 300.

In this case, the network refers to any type of conventionally known communication network including the Internet, a mobile communication network, or a combination thereof.

Furthermore, each of the first and second user terminals 200 and 300 refers to a conventionally and commonly known terminal, such as a mobile communication terminal, e.g., a computer, tablet PC or smartphone, or the like. Each of the first and second user terminals 200 and 300 includes a display unit, an input device, and a network communication means.

Based on the above-described configuration, the system 100 according to the present invention provides various game services based on mathematical principles to users via the user terminals 200 and 300.

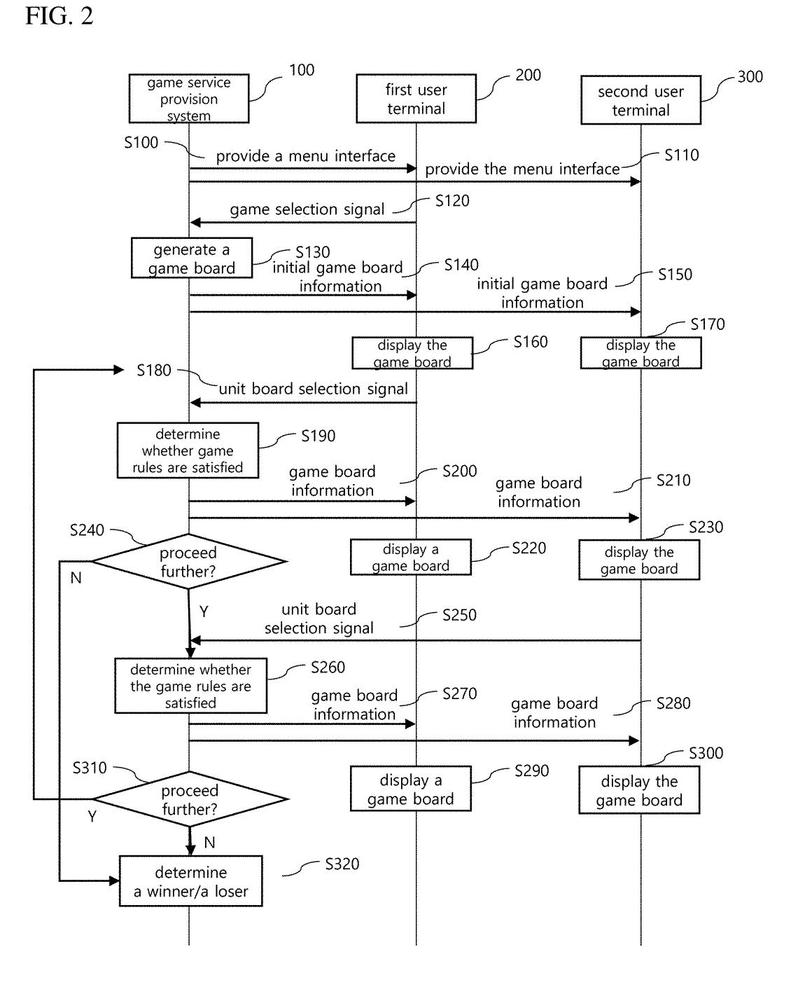

FIG. 2 is a flowchart showing a game service provision method that is performed in the system 100.

First, at steps S100 and S110, the system 100 provides the first and second user terminals 200 and 300 with a menu interface configured to show a plurality of game types according to game rules based on mathematical principles to be used in game service.

In this case, the menu interface is an interface that includes brief descriptions of game types and games so that a user can view them and make a selection by means of a mouse or the like.

Each of the first and second user terminals 200 and 300 displays the menu interface via the display unit thereof, and a user views the game types and the game rules provided in the menu interface and selects a desired game.

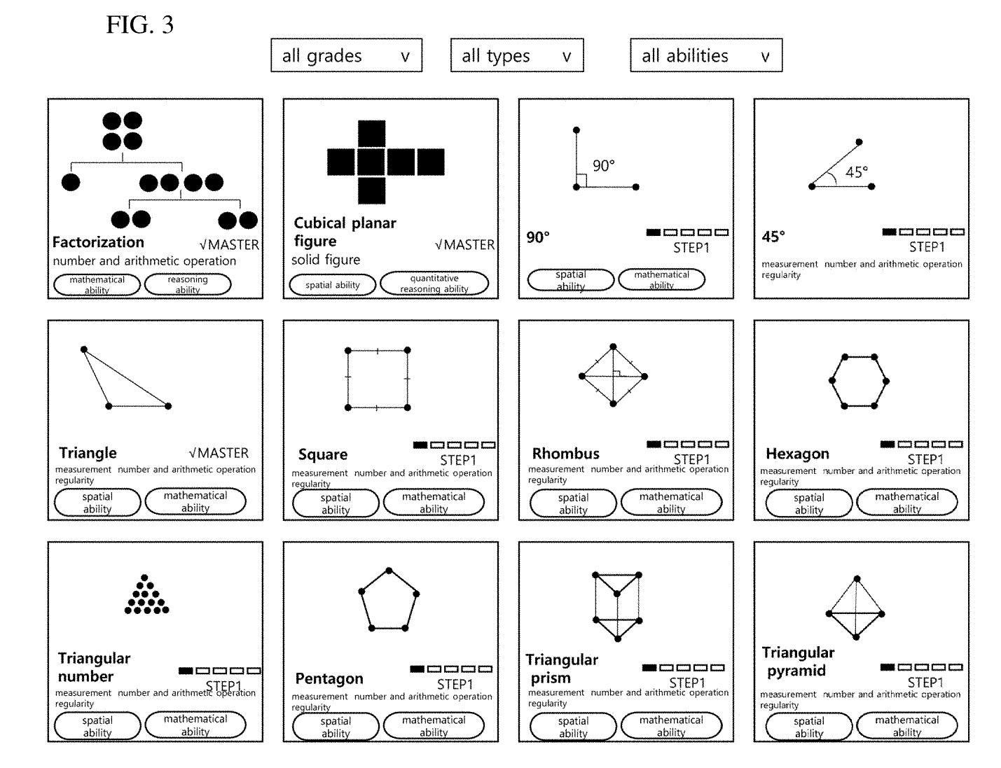

FIG. 3 is a screen showing an example of the menu interface.

When the menu interface, such as that shown in FIG. 3, is displayed on the display unit of each of the user terminals 200 and 300, a user may select a desired game from a plurality of games displayed on the menu interface.

Once the user has selected a desired game via the menu interface, a game selection signal corresponding to the selected game is transmitted to the system 100 at step S110. The selection of a game may be made by any one of the first and second user terminals 200 and 300. In FIG. 2, it is assumed that the first user terminal 200 selects a game. The game selection signal includes game identification information (ID).

Upon receiving the game selection signal, the system 100 generates a matrix-shaped game board including M×N unit boards as an initial step for providing the user with a game service corresponding to the received game selection signal at step S130, and transmits initial game board information adapted to enable the generated game board to be displayed via the display units of the first and second user terminals 200 and 300 to the first and second user terminals 200 and 300 at steps S140 and S150.

In this case, M and N are desired natural numbers, and may have the same value. The values of M and N may be set by the system 100 as desired, or may be set to fixed values.

Alternatively, before the game board is generated, an interface configured to enable M and N to be set may be provided to the first and second user terminals 200 and 300, and values entered by the user may be used.

The first and second user terminals 200 and 300 display the matrix-shaped game board including M×N unit boards on their display units based on the received initial game board information at steps S160 and S170. In this case, an initial first game board displays all the M×N unit boards in a not-in-use state.

In this case, passages adapted to describe game rules for the corresponding game may be displayed such that the user can recognize them.

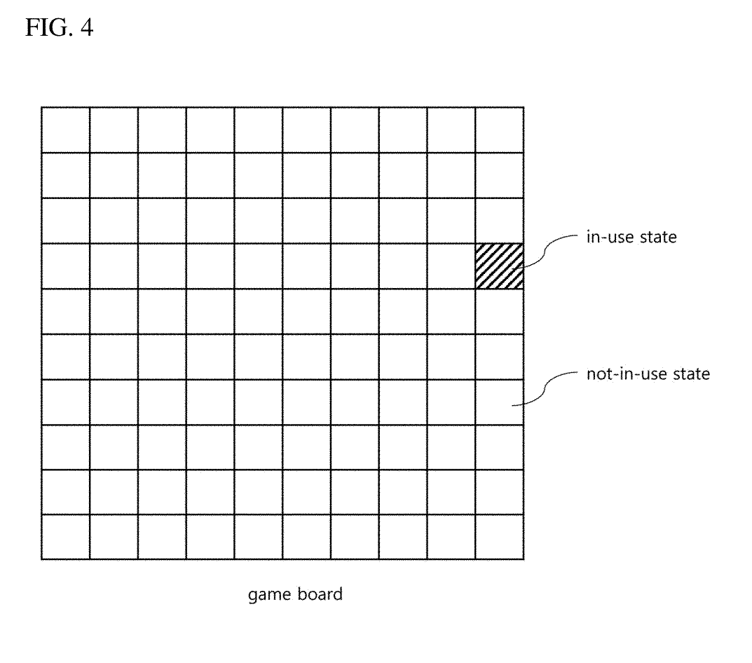

FIG. 4 shows an example of the game board that is displayed on the display units of the user terminals 200 and 300.

It can be seen that the game board of FIG. 4 has a matrix shape in which M=N=10 and is formed in a matrix shape by M×N=100 unit boards.

In FIG. 3, a unit board marked with an inclined line pattern represents a unit board in an in-use state, and unit boards shown in white represent unit boards in a not-in-use state.

When the initial game board is displayed at steps S160 and S170, all the unit boards are displayed in white representative of a not-in-use state.

Referring back to FIG. 2, a detailed process of performing game service will be described.

In a state in which the game board in which all the M×N unit boards have been displayed in a not-in-use state has been displayed as described above, any one of the users of the first and second user terminals 200 and 300 starts to select at least one unit board and a unit board selection signal for the selected unit board is transmitted to the system 100 at step S180. In the embodiment of FIG. 2, it is assumed that the first user terminal 200 selects at least one unit board first.

In this case, the selection of the unit board is made by the user so that the game rules for the selected game can be satisfied. The user is previously aware of the game rules on the previously described menu interface or game board screen, and selects a unit board, satisfying the corresponding game rules, via the displayed game board.

In this case, the game rules are based on various mathematical principles, and enable a user to easily learn the principles of figures and arithmetic operations via the game board. In other words, the present invention is characterized by enabling a user to use the game service using the game board based on the game rules configured to associate the principles of a figure or arithmetic operation with the game board. The game rules vary depending on a game selected by the user via the menu interface.

The detailed game rules used in the present invention may be basically classified into two types of rules, i.e., figure-based rules and arithmetic operation-based rules.

The figure-based rules refer to rules that allow the shape of a specific figure to be indicated on the game board by using some of the unit boards.

In this case, the figure may be a plane figure or solid figure.

The plane figure includes a triangle, a rectangle, a rhombus, a pentagon, a hexagon, a trapezoid, a parallelogram, etc., and the vertices or sides of the plane figure may be allowed to be indicated to be associated with some of the unit boards.

The solid figure includes a regular tetrahedron, a cube, a triangular prism, a triangular pyramid, etc., and the vertices of the solid figure may be allowed to be indicated to be associated with some of the unit boards.

The arithmetic operation-based rules refer to rules that allow the result of a specific arithmetic operation to be indicated on the game board by using some of the unit boards.

In this case, the arithmetic operation includes factorization into prism factors, factorization, division, multiplication, an equation, a proportional expression, etc., and the arithmetic operation-based rules refer to rules that allow the result of performance of such an arithmetic operation to be indicated by using some of the unit boards.

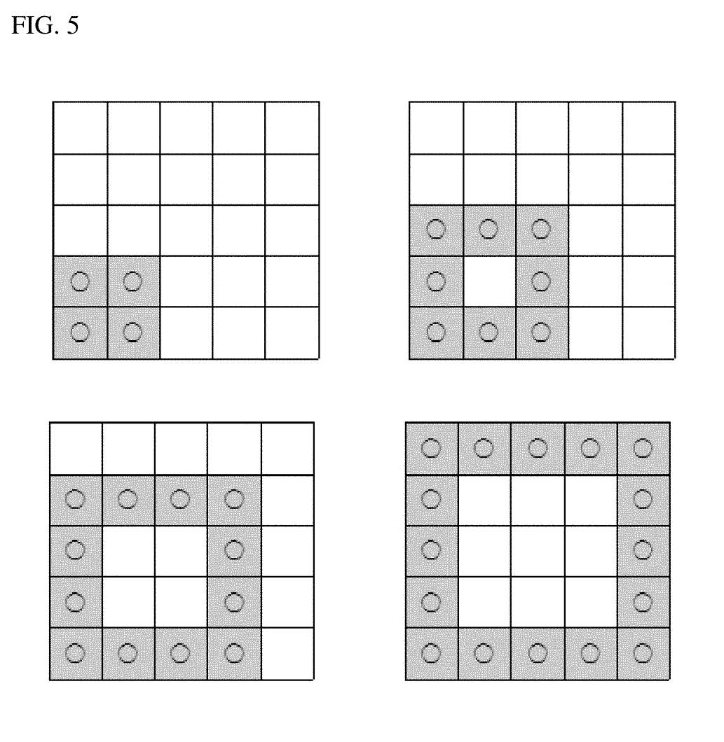

FIG. 5 is a view illustrating a case where game rules are figure (rectangle)-based rules.

In FIG. 5, it can be seen that the unit boards indicated by circles and gray are displayed to be associated with the sides of a rectangle. When the users of the user terminals 200 and 300 alternately select the unit boards in the shapes shown in FIG. 5, the game rules are satisfied.

Although unit boards are allowed to be selected to be associated with the sides of a rectangle in FIG. 5, unit boards may be allowed to be selected to be associated with the vertices of the rectangle.

When the user of the first user terminal 200 selects a unit board in accordance with, e.g., the rules shown in FIG. 5, a unit board selection signal for the selected unit board is transmitted to the system 100 at step S180, and the system 100 determines whether the game rules for the selected game are satisfied by the unit board based on the received unit board selection signal at step S190. In this case, the unit board selection signal may include the identification information (coordinate information) of the unit board.

When the game rules are satisfied, the system 100 transmits game board information adapted to enable a game board to be displayed according to the corresponding unit board selection signal to the first and second user terminals 200 and 300, and the first and second user terminals 200 and 300 renew the game board based on the game board information at steps S190 to S230.

Furthermore, the system 100 determines whether the game can proceed further at step S240. Whether the game can proceed further is determined based on whether a unit board satisfying the game rules can be selected from unit boards in a not-in-use state on the game board.

When the game cannot proceed further, the method moves to step S320 of determining a winner/a loser. When the game can proceed further, the method moves to subsequent step S250, where the subsequent step of receiving a unit board selection signal from the second user terminal 300 is performed.

In other words, when the user of the second user terminal 300 selects a unit board in accordance with, e.g., the rules shown in FIG. 5 at a subsequent step, a unit board selection signal for the selected unit board is transmitted to the system 100 at step S250, and whether the game rules are satisfied is determined in the same manner as in steps S190 to S230. When the game rules are satisfied, game board information is transmitted to the first and second user terminals 200 and 300, and thus the first and second user terminals 200 and 300 renew the game board on the display units at steps S260 to S300.

Furthermore, the system 100 determines whether the game can proceed further in the same manner as in step S240. When the game can proceed further, the method returns to step S180, and a unit board selection signal is re-received from the first user terminal 200. When the game cannot proceed further, the method moves to step S320 of determining a winner/a loser.

Step S320 of determining a winner/a loser is performed using a method of determining that the user of the user terminal 200 or 300 at a corresponding sequential position when a unit board satisfying the game rules cannot be selected from unit boards in a not-in-use state is a loser. In other words, when it is determined at step S240 that the game cannot proceed further, it is determined that the user of the second user terminal 300 is a loser. When it is determined at step S320 that the game cannot proceed further, it is determined that the user of the first user terminal 200 is a loser.

Once the winner/the loser have been determined, the system 100 transmits information indicating the winner/the loser to the first and second user terminals 200 and 300, and the first and second user terminals 200 and 300 may receive the information and display the winner/loser information via their display units.

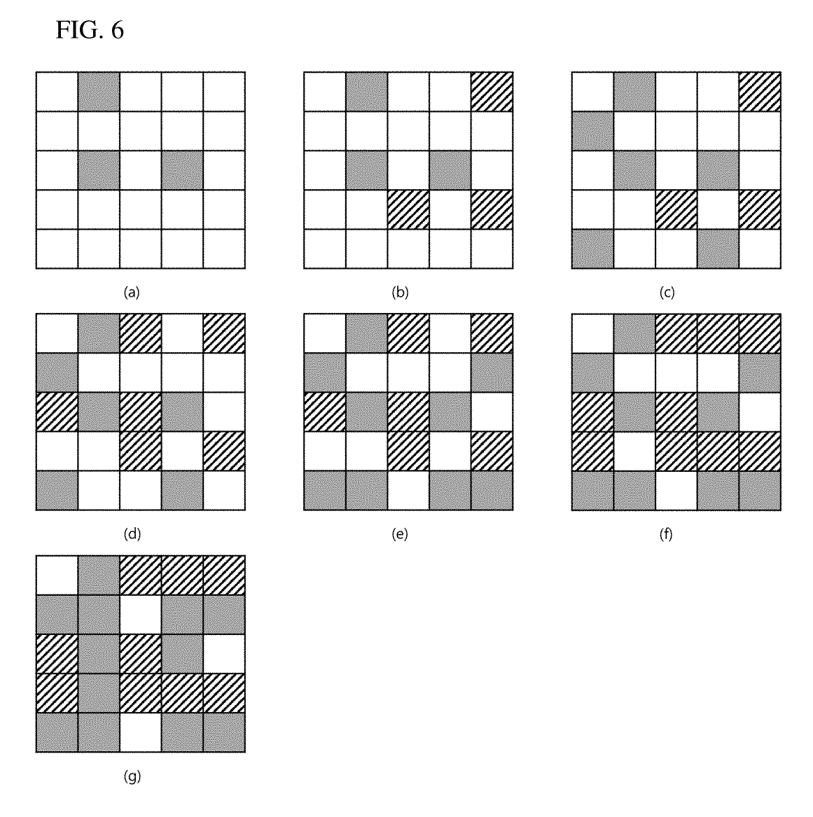

FIG. 6 shows an example of the game service provision method according to the present invention, which shows a case where game rules are figure-based rules and a figure is a right-angled triangle.

In FIG. 6, white represents unit boards in a not-in-use state, unit boards displayed in gray represent the unit boards selected by the first user terminal 200, and unit boards marked with an inclined line pattern represent the unit boards selected by the second user terminal 300. Furthermore, in the game boards of FIG. 6, M=N=5. Each of the game boards includes a total of 25 unit boards. The game rules of FIG. 6 allow a user to select unit boards corresponding to the vertices of a triangle from the game board.

First, the user of the first user terminal 200 (hereinafter referred to as user 1) selects three unit boards, as shown in FIG. 6(a). A unit board selection signal for the selected unit boards is transmitted to the system 100, and the selected unit boards satisfy the game rules because they correspond to the vertices of a right-angled triangle. Accordingly, the system 100 transmits game board information to the first and second user terminals 300 to thus allow a game board to be renewed, and waits for a unit board selection signal from the second user terminal 300 at a subsequent sequential position.

At the subsequent sequential position, the user of the second user terminal 300 (hereinafter referred to as user 2) selects three unit boards, as shown in FIG. 6(b). A unit board selection signal for the selected unit boards is transmitted to the system 100, and the selected unit boards satisfy the game rules because they correspond to the vertices of a right-angled triangle. Accordingly, the system 100 transmits game board information to the first and second user terminals 300 to thus allow a game board to be renewed, and waits for a unit board selection signal from the first user terminal 200 at a subsequent sequential position.

A process in which the first and second user terminals 200 and 300 repeat the above process is performed, as shown in FIGS. 6(c) to 6(g). The state of FIG. 6(g) is a state in which a unit board corresponding to a vertex of the right-angled triangle cannot be selected any longer, and thus the system 100 determines that the user of the user terminal 200 or 300 (the user of the second user terminal 300) corresponding to a sequential position at which it is required that a unit board is selected at this time is a loser.

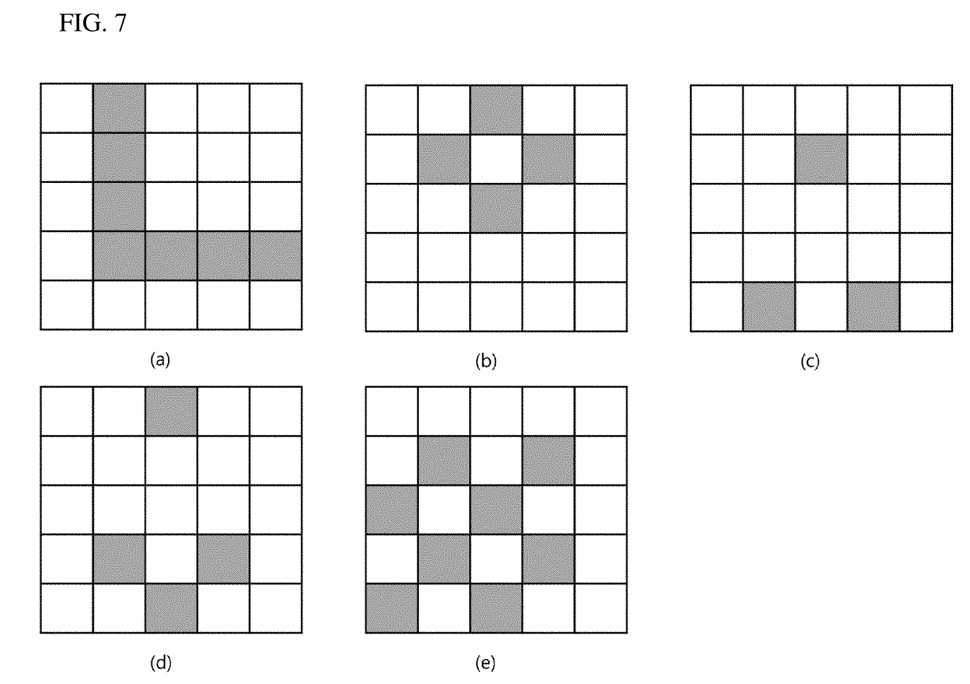

FIG. 7 shows other examples of the figure-based rules.

FIG. 7(a) is directed to a case where the sides of a right-angled triangle are allowed to be indicated on unit boards correspondingly. When selected unit boards correspond to sides of a right-angled triangle, game rules are satisfied.

FIG. 7(b) is directed to a case where the vertices of a rhombus are allowed to be indicated on unit boards correspondingly. When selected unit boards correspond to vertices of a rhombus, game rules are satisfied.

FIG. 7(c) is directed to a case where the vertices of an acute triangle are allowed to be indicated on unit boards correspondingly. When selected unit boards correspond to vertices of an acute triangle, game rules are satisfied.

FIG. 7(d) is directed to a case where the vertices of a triangular pyramid, i.e., a solid figure, are allowed to be indicated on unit boards correspondingly. When selected unit boards correspond to vertices of a triangular pyramid, game rules are satisfied.

FIG. 7(e) is directed to a case where the vertices of a cube, i.e., a solid figure, are allowed to be indicated on unit boards correspondingly. When selected unit boards correspond to vertices of a cube, game rules are satisfied.

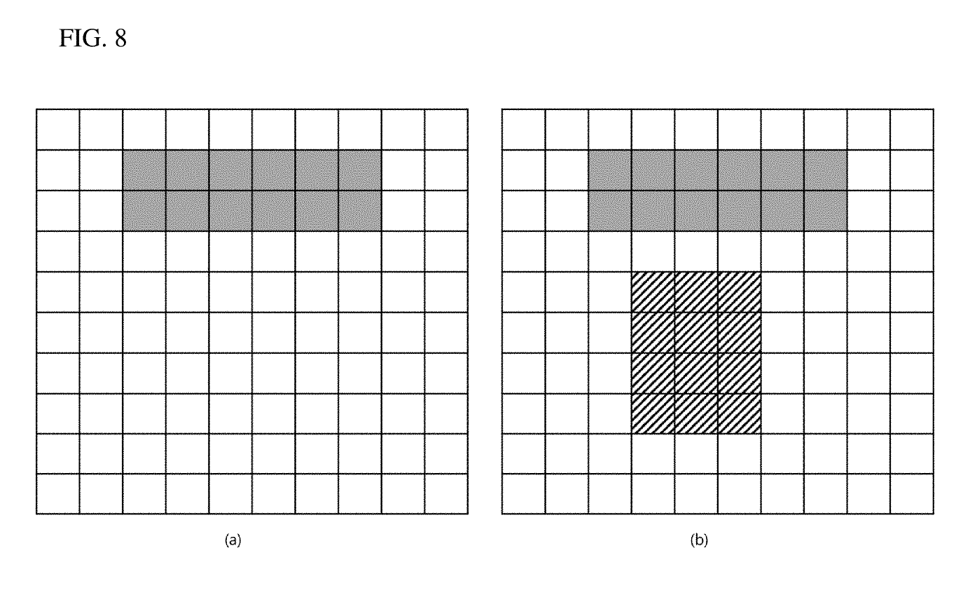

FIG. 8 shows another example of the game service provision method according to the present invention, which shows a case where game rules are arithmetic operation-based rules and an arithmetic operation is factorization.

Also in FIG. 8, white represents unit boards in a not-in-use state, unit boards displayed in gray represent the unit boards selected by the first user terminal 200, and unit boards marked with an inclined line pattern represent the unit boards selected by the second user terminal 300. Furthermore, in the game boards of FIG. 8, M=N=10. Each of the game boards includes a total of 100 unit boards.

The game rules of FIG. 6 allow a user to select unit boards corresponding to the vertices of a triangle from the game board.

The game rules of FIG. 8 allow a user to resolve a specific natural number n into two factors a and b and to select unit boards from the game board in an a×b form.

In FIG. 8, it is assumed that n=12. n may be set in such a manner that after receiving a game board selection signal and before generating a game board, an interface configured to enable n to be set is provided to the first and second user terminals 200 and 300 and a value entered by a user via the interface is used, as described above. Furthermore, the value of n may be set by the system 100 as desired, or may be set to a fixed value.

First, the user of the first user terminal 200 (hereinafter referred to as user 1) selects unit boards in a 2×6 form, as shown in FIG. 8(a). A unit board selection signal for the selected unit boards is transmitted to the system 100, and the selected unit boards satisfy the game rules because they have an n=a×b (12=2×6) form and are the result of the factorization of 12. Accordingly, the system 100 transmits game board information to the first and second user terminals 300 to thus allow the game board to be renewed, and waits for a unit board selection signal from the second user terminal 300 at a subsequent sequential position.

At the subsequent sequential position, the user of the second user terminal 300 (hereinafter referred to as user 2) selects unit boards in a 3×4 form, as shown in FIG. 8(b). A unit board selection signal for the selected unit boards is transmitted to the system 100, and the selected unit boards satisfy the game rules because they have an n=a×b (12=3×4) form and are the result of the factorization of 12. Accordingly, the system 100 transmits game board information to the first and second user terminals 300 to thus allow the game board to be renewed, and waits for a unit board selection signal from the first user terminal 200 at a subsequent sequential position.

The above process is repeated until there is reached a state in which a unit board cannot be selected in an n=a×b form any longer. It is determined that the user of one of the user terminals 200 and 300 corresponding to a sequential position at which it is required that a unit board is selected at this time is a loser.

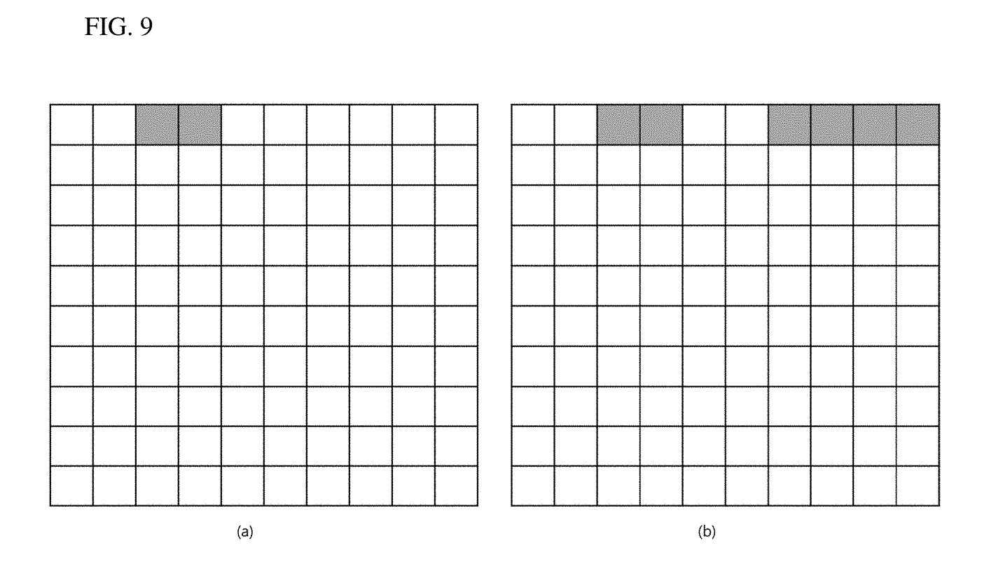

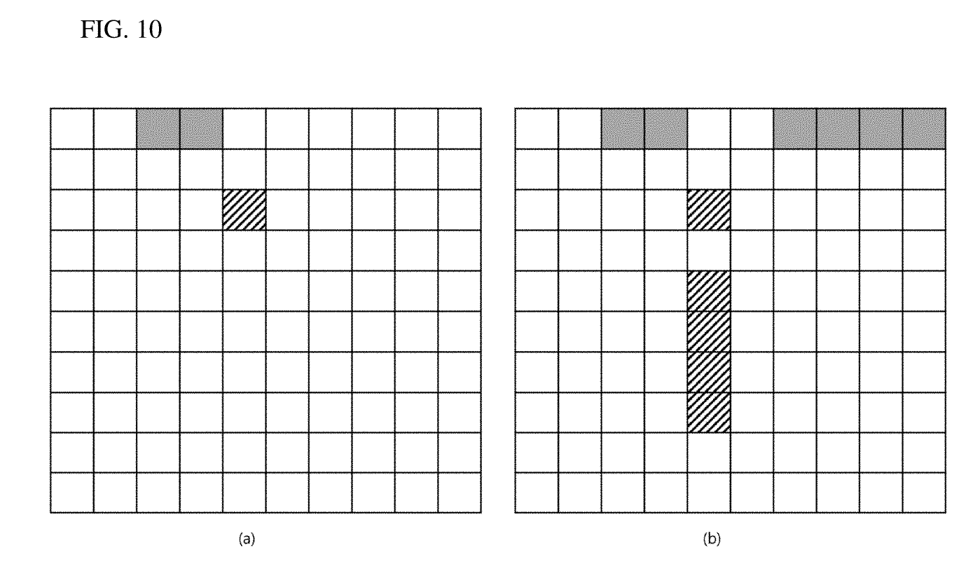

FIGS. 9 and 10 show other examples of the arithmetic operation-based rules.

FIGS. 9 and 10 are directed to a case where a multiple a is set, a number b desired by a user is set and indicated on one or more unit boards correspondingly to be connected in a lateral or vertical form, and the product of the multiple a and the number b desired by the user is indicated not to be connected to the unit boards indicated in a row or column.

From FIG. 9(a), it can be seen that when a multiple a is set to 2 and the number b desired by the user is 2, the number b desired by the user is 2, i.e., two unit boards, are indicated to be connected to each other. From FIG. 9(b), it can be seen that four unit boards, i.e., the result of the product of the multiple a (=2) and the number a (=2) desired by the user, are indicated in the same row not to be connected to the unit boards indicated in FIG. 9(a).

In the above state, a user at a subsequent sequential position sets a multiple a to 4, sets a number b, desired by the user, to 1, and selects and indicates the number b, i.e., one unit board, as shown in FIG. 10(a). Furthermore, as shown in FIG. 10(b), a×b=4×1=4 unit boards are indicated in the same row not to be connected to the unit boards indicated in FIG. 10(a).

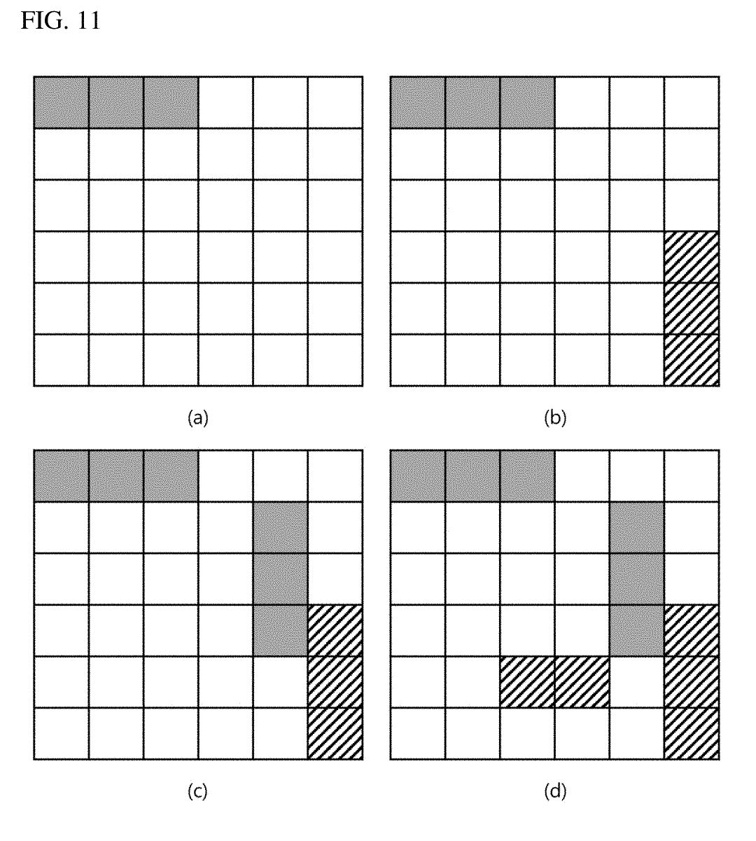

FIG. 11 shows another example of the arithmetic operation-based rules, and is directed to a case where a specific number n is set, an arithmetic operation of ×1/n (where the result thereof is truncated to its positive integer) is performed on connected unit boards in a not-in-use state in a specific row or column of a game board, and a number of unit boards equal to a value corresponding to the result value of the operation are connected to each other.

In FIG. 11, when n is 2, a user selects 6×(1/2)=3 unit boards to be connected to one another because the number of unit boards in a not-in-use state is 6 in the first row in FIG. 11(a). Furthermore, users select unit boards to be connected to each other in the same manner, as shown in FIGS. 11(b) and 11(c).

Thereafter, the number of connected unit boards in a not-in-use state in the fifth row is 5, and thus 5×(1/2)=2 (truncated to its positive integer). Accordingly, a corresponding user selects two unit boards to be connected in the fifth row, as shown in FIG. 11(d).

Via the above-described process, the users may naturally acquire a mathematical principle by means of the game rules used, i.e., figure or arithmetic operation-based rules, while playing a game in accordance with the game rules based on the mathematical principle.

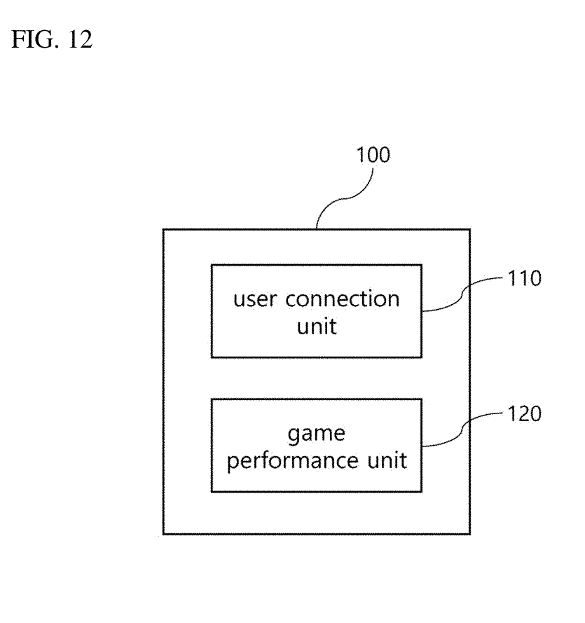

FIG. 12 shows the configuration of the system 100 that performs the game service provision methods described with reference to FIGS. 1 to 11.

Referring to FIG. 12, the system 100 includes a user connection unit 110 and a game performance unit 120.

The user connection unit 110 is responsible for the function of transmitting and receiving data required for performing game service according to the present invention while operating in conjunction with the user terminals 200 and 300. In other words, the user connection unit 110 provides a menu interface configured to enable a game to be selected from a plurality of games to the first and second user terminals 200 and 300, and receives a game selection signal for a game selected by any one of the first and second user terminals 200 and 300 via the menu interface.

Furthermore, the user connection unit 110 performs the function of transmitting game board information adapted to enable a not-in-use state to be indicated on a game board including M×N unit boards, generated by the game performance unit 120, to the user terminals 200 and 300.

Furthermore, the user connection unit 110 performs the function of alternately receiving unit board selection signals for unit boards in a not-in-use state from the first and second user terminals 200 and 300 and transmitting game board information adapted to enable the selected unit boards to be indicated in an in-use state on the game board displayed on the display units of the first and second user terminals 200 and 300 according to the result of whether the game rules are satisfied determined by the game performance unit 120.

Meanwhile, the game performance unit 120 performs the function of generating a matrix-shaped game board including M×N unit boards and allowing the M×N unit boards to be indicated in a not-in-use state on the game board through the display units of the first and second user terminals 200 and 300 via the user connection unit 110.

Furthermore, the game performance unit 120 is responsible for the function of determining whether the shape of the unit boards selected by the unit board selection signals received from the first and second user terminals 200 and 300 satisfies the game rules for the selected game based on the unit board selection signals and, when it is determined that the game rules are satisfied, repeating a process of transmitting game board information so that the selected unit boards can be indicated in an in-use state on the game board displayed on the display units of the first and second user terminals 200 and 300 via the user connection unit 110 until a unit board satisfying the game rules cannot be selected from unit boards in a not-in-use state.

Furthermore, the game performance unit 120 also performs the function of determining that the user of one of the user terminals corresponding to a sequential position when a unit board satisfying the game rules cannot be selected from unit boards in a not-in-use state is a loser.

While the present invention has been described above with reference to the preferred embodiments of the present invention, the present invention is not limited to the above embodiments.

For example, although the case where two user terminals use game service has been taken as an example in the above embodiments, more than two user terminals may use game service.

Furthermore, the system 100 and a user may use game service one to one. In this case, the system 100 functions as a second user terminal.

Furthermore, the game rules described in the above embodiments are illustrative, and various other game rules may be used.

For example, as the figure-based rules, the vertices or sides of figures, such as a circle, an isosceles right-angled triangle, a triangle, an isosceles triangle, an obtuse triangle, a square, a pentagon, a hexagon, a sector, a rectangle, a trapezoid, a parallelogram, a rectangle, etc., other than the figures described as examples, may be allowed to be indicated using unit boards.

Furthermore, a specific angle (for example, 45 degrees, or 90 degrees) may be allowed to be indicated by selected unit boards. Furthermore, the vertices of a specific figure may be allowed to be indicated, and a state in which they have been inverted or rotated may be allowed to be indicated.

Furthermore, a specific shape may be allowed to be indicated, and it may be allowed to be indicated in a line or point symmetric shape.

Furthermore, a planar figure of a specific solid figure may be allowed to be indicated using unit boards, or a specific three-dimensional object may be allowed to be indicated in a set of six drawings.

Furthermore, as the arithmetic operation-based rules, any linear equation ax=b may be allowed to be selected, unit boards corresponding to a may be allowed to be indicated on connected unit boards in a not-in-use state, and unit boards corresponding to b may be allowed to be indicated above or below the unit boards corresponding to a in an overlap manner.

Furthermore, there may be played a multiple-based game in which a user is allowed to select one, two, or four unit boards and a number of unit boards equal to a number obtained by multiplying or dividing the number of unit boards, selected by the corresponding user, by 2 are allowed to be selected.

Furthermore, a direct proportion-based game in which a process in which one or more unit boards, for example, within the range of one to three unit boards are allowed to be connected in an upward or right direction from the leftmost unit board in the lowermost row of a game board and to be selected in a row or column direction is alternately performed and a user who reaches the rightmost unit board in the uppermost row is judged to be a winner may be used as the game rules.

Furthermore, a natural number-based game in which natural numbers within a specific range are allowed to be indicated on unit boards in connected forms may be used as the game rules.

Furthermore, an inequality-based game in which, by using a specific inequality, e.g., 3<4, one user is allowed to indicate three unit boards and the other user is allowed to indicate four unit boards may be used as the game rules.

Furthermore, a triangular number-based game in which a value obtained by adding 1 to n together is allowed to be indicated on unit boards correspondingly may be used as the game rules.

Furthermore, although the shape of the game board has been described as a matrix shape in the above-described embodiments, it may be extended to various other shapes, i.e., a triangle, a circle, a point, etc.

1. A method of providing game service based on mathematical principles, the method comprising:
a first step of receiving a game selection signal from any one of first and second user terminals;
a second step of generating a matrix-shaped game board including M×N unit boards (where M and N are natural numbers), and allowing the M×N unit boards to be indicated in a not-in-use state on the game board via display units of the first and second user terminals;
a third step of alternately receiving unit board selection signals for unit boards in a not-in-use state from the first and second user terminals, and repeating a process of allowing the selected unit boards to be indicated in an in-use state on the game board displayed on the display units of the first and second user terminals when a shape of the unit boards selected by the unit board selection signals satisfies game rules for a selected game until a unit board satisfying the game rules cannot be selected from unit boards in a not-in-use state; and
a fourth step of determining that a user of one of the user terminals corresponding to a sequential position when a unit board satisfying the game rules cannot be selected from unit boards in a not-in-use state is a loser.

2. The method of claim 1, further comprising, before the first step, a step of providing a menu interface configured to enable a game to be selected from a plurality of games to the first and second user terminals and receiving a game selection signal for a game selected by any one of the first and second user terminals via the menu interface.

3. The method of claim 1, wherein the third step comprises transmitting game board information to the first and second user terminals so that the selected unit boards can be indicated in an in-use state on the game board displayed on the display units of the first and second user terminals when the shape of the unit boards selected by the unit board selection signals satisfies the game rules for the selected game, and renewing, by the first and second user terminals, the game board on the display units based on the received game board information.

4. The method of claim 1, wherein the game rules are figure-based rules configured to allow a shape of a specific figure to be indicated on the game board by using some of the unit boards.

5. The method of claim 4, wherein the figure-based rules allow vertices of a plane figure or solid figure to be indicated on the game board by using some of the unit boards.

6. The method of claim 4, wherein the figure-based rules allow sides of a plane figure or solid figure to be indicated on the game board by using some of the unit boards.

7. The method of claim 6, wherein the plane figure is any one of a triangle, a rectangle, a pentagon, a hexagon, a rhombus, and a circle, and the solid figure is any one of a tetrahedron, a triangular pyramid, a hexahedron, and a triangular prism.

8. The method of claim 6, wherein the figure-based rules allow a planar figure, line symmetric or point symmetric shape of the plane figure or solid figure to be indicated on the game board by using some of the unit boards.

9. The method of claim 1, wherein the game rules are arithmetic operation-based rules configured to allow a result of an arithmetic operation to be indicated on the game board by using some of the unit boards.

10. The method of claim 9, wherein the arithmetic operation is any one of factorization into prism factors, factorization, division, multiplication, an equation, and a proportional expression.

11. A game service provision system for providing the game service provision method of claim 1, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

12. A game service provision system for providing the game service provision method of claim 2, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

13. A game service provision system for providing the game service provision method of claim 3, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

14. A game service provision system for providing the game service provision method of claim 4, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

15. A game service provision system for providing the game service provision method of claim 5, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

16. A game service provision system for providing the game service provision method of claim 6, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

17. A game service provision system for providing the game service provision method of claim 7, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

18. A game service provision system for providing the game service provision method of claim 8, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

19. A game service provision system for providing the game service provision method of claim 9, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.

20. A game service provision system for providing the game service provision method of claim 10, the game service provision system comprising:
a user connection unit configured to provide first and second user terminals with a menu interface configured to enable a game to be selected from a plurality of games, to receive a game selection signal for a game selected by any one of the first and second user terminals via the menu interface, and to transmit game board information adapted to enable a not-in-use state to be indicated on a game board including M×N unit boards, generated by a game performance unit, to the first and second user terminals; and
the game performance unit configured to generate a matrix-shaped game board including M×N unit boards, to allow the M×N unit boards to be indicated in a not-in-use state on the game board through display units of the first and second user terminals via the user connection unit, and to determine whether a shape of unit boards selected by unit board selection signals received from the first and second user terminals satisfies game rules for the selected game based on the unit board selection signals;
wherein when it is determined that the game rules are satisfied, the game performance unit repeats a process of transmitting game board information so that the selected unit boards can be indicated in an in-use state on the game board displayed on the display units of the first and second user terminals via the user connection unit until a unit board satisfying the game rules cannot be selected from unit boards in a not-in-use state.
